(19) United States
(12) Patent Application Publication
(10) Pub. No.: US 2015/0142328 A1
(43) Pub. Date: May 21, 2015

(54) CALCULATION METHOD FOR INTERCHROMOSOMAL TRANSLOCATION POSITION

(71) Applicant: Electronics and Telecommunications Research Institute, Daejeon (KR)

(72) Inventors: Ho-Youl JUNG, Daejeon (KR); Min-Ho KIM, Daejeon (KR); Myung-Eun LIM, Daejeon (KR); Dae-Hee KIM, Daejeon (KR); Jae-Hun CHOI, Daejeon (KR)

(21) Appl. No.: 14/542,474

(22) Filed: Nov. 14, 2014

(30) Foreign Application Priority Data
Nov. 18, 2013 (KR) 10-2013-0140204
Nov. 5, 2014 (KR) 10-2014-0152876

(51) Int. Cl. G06F 19/22; G01B 21/16

(52) U.S. Cl. CPC G06F 19/22; G01B 21/16
USPC 702/19

(57) ABSTRACT

The present invention relates to a method for calculating inter-chromosomal translocation position by using sequence read data generated through a next generation sequencing (NGS) apparatus. According to the present invention, the inter-chromosomal translocation position is determined more precisely and efficiently in base units.

### CROSS-REFERENCE TO RELATED APPLICATIONS

This application claims the benefit of Korean Patent Application No. 10-2013-0140204, filed with the Korean Intellectual Property Office on November 18, 2013, entitled “Calculation method for inter-chromosomal translocation”, and Korean Patent Application No. 10- 2014-0152876, filed with the Korean Intellectual Property Office on Nov. 5, 2014, entitled “Calculation method for inter-chromosomal translocation position”, which are hereby incorporated by reference in its entirety into this application.

### BACKGROUND

1. Technical Field

The present invention relates to a method for calculating inter-chromosomal translocation position which is a kind of chromosome structural variations using sequence read data generated by a next generation sequencing (NGS) apparatus.

2. Background Art

An inter-chromosomal translocation among chromosome structural variations is swaps in a chromosomal segment(s) between chromosomes.

There are conventional methods for predicting a chromosome structural variation based on the next generation sequencing (NGS) technology such as a method using paired end reads which are paired sequence read data and a method using soft clipped regions of sequence read data.

As already disclosed in many studies, the method using paired end reads can determine if there is an inter-chromosomal translocation or not but cannot determine where actual positions are or what actual structures are with the accuracy of base units. The method using soft clipped reads (SCR) can determine where actual positions are or what actual structures are with better accuracy of base units, compared with the conventional method using paired end reads. However, due to restrictions on that reads in which ‘soft-clipping’ occurs enough to form statistically significant consensus should exist and the ‘soft clipped’ region should be above a certain length, it results in poor accuracy, particularly in sensitivity.

### PRIOR ART

KR Patent Publication No. 2013-0116794

### SUMMARY OF THE INVENTION

The present invention provides a method for calculating inter-chromosomal translocation position which can compensate the drawbacks associated with those above mentioned two methods.

Accordingly, an object of the present invention is to provide a method for calculating inter-chromosomal translocation position which can improve accuracy to recognize structural variation of a chromosome with base units.

Another object of the present invention is to provide a method for calculating inter-chromosomal translocation position which can eliminate restrictions such as length and depth of soft-clips to be a certain length or longer or to be a certain level or above.

According to an aspect of the present invention, there is provided a method for calculating inter-chromosomal translocation position comprising: generating sequence read data from a genome to be analyzed; comparing the generated sequence read data with a reference genome; extracting soft clipped reads (SCR) from the compared result; generating soft clipped read overlap read lists (SCRORL) by extracting soft clipped reads (SCR) which overlap each other among the extracted soft clipped reads (SCR); generating a soft clipped read overlap read (SCROR) from the generated soft clipped read overlap read lists (SCRORL); generating a split read pair (SRP) from the soft clipped read overlap read (SCROR); and calculating translocation position of the genome to be analyzed by determining if the generated split read pair (SRP) exists on the same chromosome.

In an embodiment of the present invention, the step of generating a soft clipped read overlap read (SCROR) may comprise extracting overlap reads having a sequence which overlaps each other among the soft clipped reads (SCR); and generating the soft clipped read overlap read (SCROR) by performing a de Bruijn graph assembly algorithm for the overlap reads.

In an embodiment of the present invention, the step of generating a split read pair (SRP) may comprise generating a split read pair (SRP) having a number of L−1 which is 1 less than the length L of the soft clipped read overlap read (SCROR).

In an embodiment of the present invention, the step of generating a split read pair (SRP) may comprise generating split read pairs (SRP) of [1, (L−1)], [2, (L−2)], . . . [(L−2], 2), [(L−1), 1] when the length of the soft clipped read overlap read (SCROR) is “L”.

In an embodiment of the present invention, the step of calculating translocation position of the genome to be analyzed may comprise defining the generated split read pair (SRP) as a paired end read; determining if each split read of the split read pair (SRP) exists on the same chromosome by mapping the defined paired end read on the reference genome; and calculating translocation position of the genome to be analyzed by using the position of the split read when the split read does not exist on the same chromosome.

In an embodiment of the present invention, the position of the split read may be a breakpoint where the translocation of the genome to be analyzed begins.

Accordingly, the present invention allows accurately and efficiently predicting inter-chromosomal translocation position including base units.

In addition, the present invention allows calculating position and structure of inter-chromosomal translocation without any restriction.

### BRIEF DESCRIPTION OF THE DRAWINGS

FIG. 1 is a schematic view of inter-chromosomal translocation.

FIG. 2 is a flowchart illustrating a calculation method for inter-chromosomal translocation position according to the present invention

FIG. 3 is a schematic view illustrating extraction of a soft clipped read overlap read (SCROR) from soft clipped read overlap read lists (SCRORL).

FIG. 4 is a schematic view illustrating generation of split read pair list (SRPL) from the soft clipped read overlap read (SCROR). FIG. 4 includes SEQ ID NO: 1.

### DESCRIPTION OF THE EXEMPLARY EMBODIMENTS

The Sequence Listing created on Jan. 21, 2015 with a file size of 1 KB, and filed herewith in ASCII text file format as the file entitled “2015_{—}01_{—}21SEQ_LIST_K110EZ-161900US,” is hereby incorporated by reference in its entirety.

The present invention will be described below in more detail.

While the present invention has been described with reference to particular embodiments, it is to be appreciated that various changes and modifications may be made by those skilled in the art without departing from the spirit and scope of the present invention, as defined by the appended claims and their equivalents. Throughout the description of the present invention, when describing a certain technology is determined to evade the point of the present invention, the pertinent detailed description will be omitted.

While such terms as “first” and “second,” etc., may be used to describe various components, such components must not be limited to the above terms. The above terms are used only to distinguish one component from another.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

The terms used herein will be described below.

Next generation sequencing (NGS): Since large-scale information cannot be obtained and there is difficulty in automation due to complicate processes with the classic Sanger sequencing method. Solexa and Illumina have developed a new method which is highly scalable with low cost and has been called as next generation sequencing (NGS) in 2007. Commercial next generation sequencers are GS GLX of Roche, Genome Analyzer of Illumina Solexa and SOLiD of Applied Biosystems.

Paired end read: means the two ends of the same DNA molecule. When one end is sequenced, it is then turned around, and the other end be sequenced, the two sequences are paired end reads.

Soft clipped read (SCR): means that a part of a sequence read is mapped on a reference genome and the rest is not mapped.

Split read pair (SRP): means a read pair including regions split in a designated distance which are connected on a reference genome.

The present invention is to resolve the problem of low sensitivity associated with the conventional method by providing a method for calculating inter-chromosomal translocation position comprising obtaining a consensus from reads which are overlapping each other from the soft clipped reads (SCR) generated through next generation sequencing, defining as a paired end read by dividing into 2 groups, and mapping the paired end read on a reference genome.

Hereinafter, embodiments of the present invention will be described below in more detail with reference to the accompanying drawings.

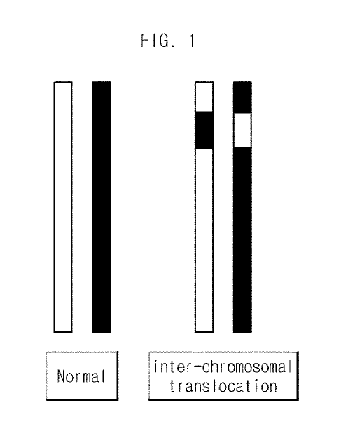

FIG. 1 is a schematic view of inter-chromosomal translocation. Left in FIG. 1 shows a pair of normal chromosomes and right does a pair of chromosomes where translocation is occurred. As shown in FIG. 1, the translocation can be occurred in a part of the pair of chromosomes and it is needed to calculate accurate position of the translocation in order to resolve problems caused by the translocation.

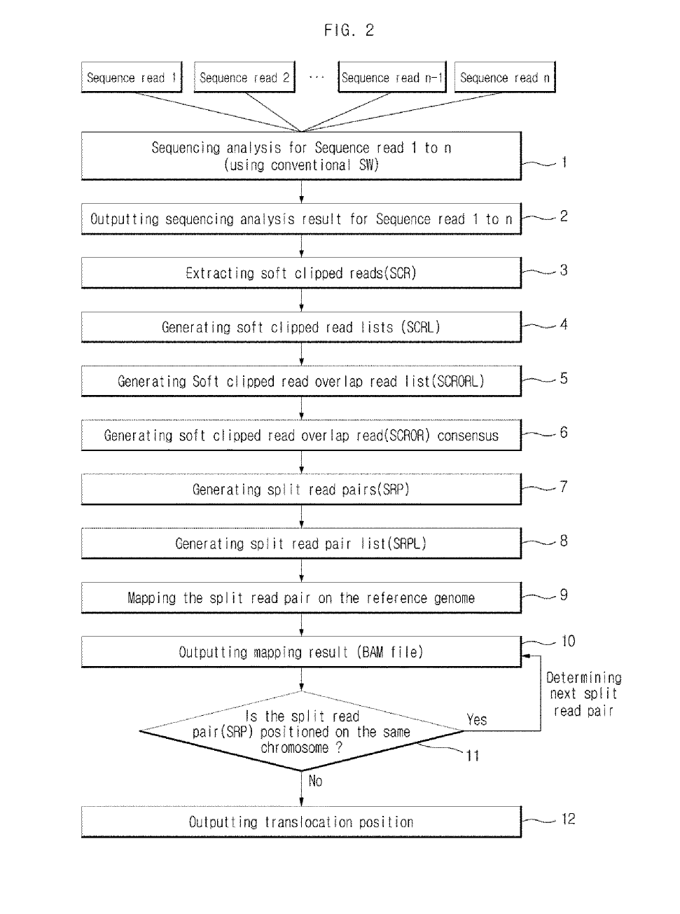

FIG. 2 is a flowchart illustrating a method for calculating inter-chromosomal translocation position and the method for calculating inter-chromosomal translocation position will be described in more detail by referring to FIG. 2.

In step 1, base sequences of a target genome are analyzed by using the next generation sequencing (NGS) technology. Contigs having the same short length are generated through the analysis. Alignment comparing the base sequence with a reference genome is performed by using a mapping software such as Burrows-Wheeler Aligner (BWA).

In step 2, the result from the step 1 may be formed into a binary sequence alignment map (BAM) file which is a binary file form of sequence alignment map (SAM).

In step 3, soft clipped reads (SCR) may be extracted from the BAM file formed in the step 2. In the method for calculating inter-chromosomal translocation position according to the present invention, after receiving BAM file reflected with the mapping state of the sequence read data on the reference genome, soft clipped reads (SCR) may be extracted therefrom. Here, entire sequence reads mapped on the reference genome can be stored or the sequence reads, in which a part is mapped on the reference genome and the rest part is not mapped on, can be stored in the BAM file. Such sequence reads are called as soft clipped reads (SCR).

The soft clipped read (SCR) may include at least one of sequencing errors and chromosome structural variations. That is, the soft clipped reads (SCR) may be ones generated by errors from the sequence read data. During the sequencing process, errors may be caused. Thus, soft clipped read (SCR) including the portion where chromosomal translocation is occurred may be used in order to eliminate such errors. The method for calculating inter-chromosomal translocation position according to an embodiment of the present invention allows extracting and using the most soft clipped reads.

In step 4, soft clipped read lists (SCRL), which are sets of soft clipped reads (SCR) extracted in the step 3, may be generated. The soft clipped read lists (SCRL) may also include a large amount of noises which are caused by sequencing errors.

In step 5, soft clipped read overlap read lists (SCRORL) may be outputted by extracting soft clipped reads (SCR) having a sequence of a part of the chromosome and overlap reads overlapping therewith from the soft clipped reads (SCR) of the soft clipped read lists (SCRL).

A method for extracting overlap reads including a sequence of soft clipped read (SCR) may be performed by using a conventional local alignment algorithm. It may be determined if a sequence of the soft clipped read (SCR) is included or not by performing a local alignment for each of the soft clipped reads (SCR) with each sequence read. Then, de Bruijn graph assembly algorithm, which is widely used in the conventional de novo assembly method, may be performed for those overlap reads including the sequence of the soft clipped read (SCR).

In step 6, a consensus sequence may be generated from the soft clipped read overlap read (SCROR) list. Here, this consensus sequence is the soft clipped read overlap read (SCROR). A fair number of soft clipped reads (SCR), generated by sequencing errors during the process of generating the soft clipped read overlap read (SCROR), may be eliminated.

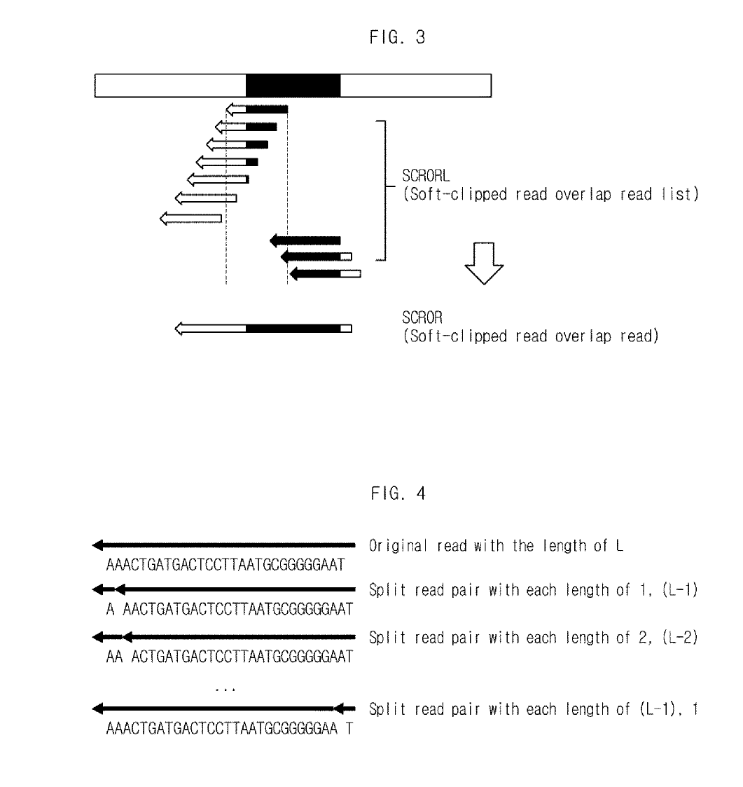

FIG. 3 is a schematic view illustrating extraction of a soft clipped read overlap read (SCROR) from soft clipped read overlap read lists (SCRORL). FIG. 3 shows an example of generation of the soft clipped read overlap read lists (SCRORL) and the soft clipped read overlap read (SCROR) which is generated by lining up the soft clipped read overlap read lists (SCRORL).

A process for generating the soft clipped read overlap read (SCROR) will be described as follows.

The soft clipped reads (SCR) are extracted from the BAM file formed in step 2 as shown in step 3 of FIG. 2 and the soft clipped read lists (SCRL) are generated from the extracted soft clipped reads (SCR) as shown in step 4 of FIG. 2. Soft clipped reads (SCR) having a sequence of a part of the chromosome and overlap reads overlapping with these soft clipped reads (SCR) may be outputted from the soft clipped read lists (SCRL) as shown in step 7 of FIG. 2. Those outputted ones are the soft clipped read overlap read lists (SCRORL) in FIG. 3. In step 8 of FIG. 2, one consensus sequence may be generated by combining read data of the soft clipped read overlap read lists (SCRORL). The consensus sequence is the soft clipped read overlap read (SCROR) as shown in FIG. 3.

Referring to FIG. 2 again, in step 7, split read pairs (SRP) may be generated from the soft clipped read overlap read (SCROR) generated in step 6. In step 8, split read pair lists (SRPL) which are sets of split read pairs (SRP) may be generated.

FIG. 4 illustrates an example of generation of split read pair lists (SRPL) from the soft clipped read overlap read (SCROR).

As shown in FIG. 4, a length of the soft clipped read (SCR) is assumed as L. A split read pair (SRP) of a (L−1) pair may be generated from the soft clipped read (SCR) in which the split read pair (SRP) is divided into 2 from the soft clipped read overlap read (SCROR). The sum of lengths of the split reads (SR) of the split read pair (SRP) may be L which is the length of the soft clipped read overlap read (SCROR). Here, the split read may be assigned as the first read and the second read.

Split read pairs (SRP) may be generated by increasing the length of the first read and decreasing that of the second read like the split read pair (SRP) having the length of 1, (L−1), that of 2, (L−2), and that of 3, (L−3). A set of split read pairs (SRP) represented by [1, (L−1)], [2, (L−2)], . . . , [(L−2), 2], [(L−1), 1] may be split read pair lists (SRPL). Referring to FIG. 2, in step 9, each split read pair (SRP) of the split read pair lists (SRPL) may be defined as a paired end read in the same direction and be mapped on the reference genome by using the software, used in step 1 of FIG. 2. In step 10, the result from step 9 may be stored in the BAM file. In step 11, it may be determines if the split read pair (SRP) is positioned on the same chromosome. It determines if chromosome translocation is occurred or not and the position thereof if there is any by determining if the split read pair (SRP) is mapped on the same chromosome by reading the BAM information. In step 11, all split read pairs (SRP) may be determined by sequentially determining each split read pair (SRP).

Therefore, in step 11, when it is determined as that the split read pair (SRP) is positioned on the same chromosome (corresponding to ‘Yes’), a next split read pair (SRP) is determined, while when it is determined as that the split read pair (SRP) is not positioned on the same chromosome (corresponding to ‘No’), the point where a breakpoint of the translocation is occurred may be outputted by indicating with base units. The split position of the split read pair (SRP) is the breakpoint of the translocation to find and such information may be outputted in step 12.

The split position of the split read pair (SRP) may include various kinds of noises before it is specified into a single position. Actual position where the inter-chromosomal translocation is occurred may be included in the various split positions included in the noises. A method for predicting inter-chromosomal translocation position more precisely may further include determining which breakpoint is close to the translocation the most stochastically among the breakpoints represented in various appearances.

For example, when breakpoints at the same position is 10% or more of total number of the split read pairs (SRP), preferably 30% or more, more preferably 50% or more, it may be determined as the position of the inter-chromosomal translocation. The more breakpoints at a particular position are, the better change is to be the position of the inter-chromosomal translocation

The method for calculating inter-chromosomal translocation position according to an embodiment of the present invention generates soft clipped read overlap reads (SCROR) and calculates the position of inter-chromosomal translocation position based thereon so that it can be free of any constraint such as that soft clipped read (SCR) should be above a certain length or above a certain depth to calculate inter-chromosomal translocation position. Since the inter-chromosomal translocation position is calculated from the split read pairs (SRP) of the soft clipped read overlap read (SCROR), the inter-chromosomal translocation position can be calculated in base units.

The spirit of the present invention has been described by way of example hereinabove, and the present invention may be variously modified, altered, and substituted by those skilled in the art to which the present invention pertains without departing from essential features of the present invention. Accordingly, the exemplary embodiments disclosed in the present invention and the accompanying drawings do not limit but describe the spirit of the present invention, and the scope of the present invention is not limited by the exemplary embodiments and accompanying drawings. The scope of the present invention should be interpreted by the following claims and it should be interpreted that all spirits equivalent to the following claims fall within the scope of the present invention.

What is claimed is:

1. A method for calculating inter-chromosomal translocation position comprising:
generating sequence read data from a genome to be analyzed;
comparing the generated sequence read data with a reference genome;
extracting soft clipped reads (SCR) from the compared result;
generating soft clipped read overlap read lists (SCRORL) by extracting soft clipped reads (SCR) which overlap each other among the extracted soft clipped reads (SCR);
generating a soft clipped read overlap read (SCROR) from the generated soft clipped read overlap read lists (SCRORL);
generating a split read pair (SRP) from the soft clipped read overlap read(SCROR); and
calculating translocation position of the genome to be analyzed by determining if the generated split read pair (SRP) exists on the same chromosome.

2. The method of claim 1, wherein the step of generating a soft clipped read overlap read (SCROR) comprises:
extracting overlap reads having a sequence which overlaps each other among the soft clipped reads (SCR); and
generating the soft clipped read overlap read (SCROR) by performing a de Bruijn graph assembly algorithm for the overlap reads.

3. The method of claim 1, wherein the step of generating a split read pair (SRP) comprises generating a split read pair (SRP) having a number of L−1 which is 1 less than the length L of the soft clipped read overlap read (SCROR).

4. The method of claim 1, wherein the step of generating a split read pair (SRP) comprises generating split read pairs (SRP) of [1, (L−1)], [2, (L−2)], . . . , [(L−2], 2), [(L−1), 1] when the length of the soft clipped read overlap read (SCROR) is L.

5. The method of claim 1, wherein the step of calculating translocation position of the genome to be analyzed comprises:
defining the generated split read pair (SRP) as a paired end read;
determining if each split read (SR) of the split read pair (SRP) exists on the same chromosome by mapping the defined paired end read on the reference genome; and
calculating translocation position of the genome to be analyzed by using the position of the split read (SR) when the split read (SR) does not exist on the same chromosome.

6. The method of claim 5, wherein the position of the split read (SR) is a breakpoint where the translocation of the genome to be analyzed begins.


SEQUENCE LISTING (1 sequence)

SEQ ID NO: 1 - DNA, 29 bp, Homo sapiens
aaactgatgactccttaatgcgggggaat